(19) United States
(12) Patent Application Publication
(10) Pub. No.: US 2005/0162283 A1
(43) Pub. Date: Jul. 28, 2005

(54) Fixed-network system for automatic meter reading having a one-way local area network

(76) Inventor: Ruben E. Salazar Cardozo, Redwood City, CA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/086,601

(22) Filed: Mar. 22, 2005

Related U.S. Application Data
(63) Continuation of application No. 09/932,234, filed on Aug. 17, 2001.

(51) Int. Cl. G08C 19/04; G08C 19/10

(52) U.S. Cl. 340/870.11

(57) ABSTRACT

A fixed-network system for automatic meter reading comprises a data collection and processing system which communicates, via wide area network, to pluralities of data concentrators, repeaters, and one-way endpoint devices which are arranged in a plurality of one-way local area networks. Each one-way local area network, or cell, is associated with a geographical area from which consumption-related data for a commodity such as electricity, natural gas, water, or steam is to be collected from the one-way endpoint devices thereof which measure and record such consumption-related data for consumers of the commodities. Each one-way local area network includes, preferably, a data concentrator, at least one repeater, and at least one one-way endpoint device. In operation, the one-way endpoint devices, generally, transmit their commodity consumption-related data via uni-directional communication links to respective repeaters of their cells which, subsequently, transmit the data to the cell's data concentrator also through respective uni-directional communication links.

### FIELD OF THE INVENTION

This invention relates generally to the field of automatic meter reading systems, and in its preferred embodiments, to fixed communication networks using substantially unidirectional communications for the automatic collection of consumption and related data from utility meters.

### BACKGROUND OF THE INVENTION

Automatic meter reading systems are currently employed by utility companies, meter reading and/or billing service providers, and others to read and collect data from meters which measure and record the consumption, by consumers (i.e., customers), of commodities such as electricity, natural gas, water, and steam. The meters of the automatic meter reading systems are located at system endpoints such as residences, businesses, or other facilities where the commodities are consumed by respective consumers. Hence, the meters are often referred to as endpoint devices. Typically, the meters have low-power transmitters which enable the meters to communicate consumption-related data to mobile data collection devices (i.e., handheld or vehicle-mounted) positionable within range of the meters' transmitters by meter reading personnel. Because most such meters transmit consumption-related data, but essentially do not receive data (i.e., although some such meters are capable of receiving minimal data in the form of a “wake-up” message), they are known, more particularly, as “one-way endpoint devices”. The use of mobile data collection devices enables the collection of consumption-related data from such meters on, generally, a monthly basis, but does not allow the collection of consumption-related data at the more frequent periods of time necessary for certain billing and diagnostic techniques. For instance, under a “time of use” billing tariff, a consumer is billed by a commodity supplier at different rates for the consumption of a commodity during different respective periods of time over the course of a day. Similarly, during performance of a load survey (i.e., to determine the commodity consumption patterns, if any, of a consumer), a commodity supplier monitors a consumer's consumption of a commodity at pre-determined intervals of time during a day. As a consequence, for time of use billing and load surveys, consumption-related data must be collected from the consumer's meters more often than is possible through the use of mobile data collection devices.

The reading and collection of consumption-related data from consumer's meters through the use of mobile data collection devices also suffers from the shortcoming of being costly. The use of handheld data collection devices requires that meter reading personnel position themselves (i.e., by walking) at a location inside the transmission range of a meter to be read, but outside the transmission range of the meters of other consumers. The costs associated with salaries and overhead for such meter reading personnel seemingly increase daily. Vehicle-mounted data collection devices, generally, require the purchase of dedicated vehicles and the retrofitting of each vehicle with a plurality of analog receivers working in parallel to receive consumption-related data from a number of meters which may attempt to transmit their consumption-related data at the same time. In addition to the ever-increasing costs associated with personnel to drive the vehicles, such dedicated vehicles and analog receivers may be costly to purchase, adapt, and operate.

In an attempt at resolving some of the shortcomings of the use of mobile data collection devices to collect commodity consumption-related data without requiring the replacement of a large number of meters, certain manufacturers of automatic meter reading systems have proposed at least two configurations of fixed-network (also referred to herein as “fixed communication network”) systems for automatic meter reading which utilize existing one-way endpoint devices. A first proposed configuration utilizes one-way endpoint devices which transmit short messages with low power levels (i.e., below one milliwatt effective radiated power). One-way endpoint devices of the first configuration comprise those which utilize the ENSCAN protocol for data transmission, including such devices manufactured by Itron, Inc. of Spokane, Wash. A second configuration utilizes one-way endpoint devices which transmit longer messages with higher power levels (i.e., commonly around 100 milliwatts effective radiated power, but up to one watt effective radiated power). One-way endpoint devices of the second configuration comprise those which utilize the SURF protocol, including such devices manufactured by Schlumberger Resource Management Services, Inc. of San Carlos, Calif.

Both of the above-identified proposed configurations employ a cellular architecture having a plurality of cells 10 to provide automatic meter reading for the meters of a particular geographical area. Each cell 10 would be associated with a portion of the meters of the geographical area and, as seen in FIG. 1, would comprise a plurality of one-way endpoint devices 12, a plurality of repeaters 14, and a data concentrator 16. The plurality of one-way endpoint devices 12 would include a first plurality of one-way endpoint devices 12₁ linked by respective “first-level” unidirectional communication links 18₁ to a first repeater 14₁ of the plurality of repeaters 14, a second plurality of one-way endpoint devices 12₂ linked by respective “first-level” unidirectional communication links 18₂ to a second repeater 14₂ of the plurality of repeaters 14, and as indicated by use of the subscript “N” in FIG. 1, other pluralities of one-way end-point devices 12_{N} linked by respective “first-level” unidirectional communication links 18₁ to an N^{th} repeater 14^{N} of the plurality of repeaters 14. Each repeater 14 of the plurality of repeaters 14 would be linked to the data concentrator 16 by a respective “second-level” bi-directional communication link 20 (i.e., designated in FIG. 1 with subscripts 1 to “N”). The data concentrator 16 would also connect to an existing wide area network (i.e., “WAN”) via a bi-directional communication link 22. Generally, the wide area network would include, for example, the public switched telephone network (“PSTN”), cellular telephone networks, CPDP systems, satellite communication systems, cable television systems, and other communication systems acceptable for the communication of data to a common data collection system. Although not shown in FIG. 1, the data concentrator 16 of a cell 10 might additionally connect, by bi-directional communication links, to the data concentrators of adjacent cells. Together, the one-way endpoint devices 12, repeaters 14, data concentrator 16, and communication links 18, 20 would form a local area network (“LAN”) for the collection and communication of consumption-related data.

In operation, the one-way endpoint devices 12 of a cell 10 would communicate their consumption-related data to their respective repeaters 14 via respective “first-level” unidirectional communication links 18. Repeaters 14 would then communicate the received consumption-related data to the cell's data concentrator 16 through respective “second-level” bi-directional communication links 22. The data concentrator 16 would collect the consumption-related data from the repeaters 14 and communicate the data, via a wide area network to a common data collection system which would store the consumption-related data from the plurality of cells 10 and perform appropriate processing of the data. The data concentrator 16 could also operate as a data repeater, if connected to a data concentrator of an adjacent cell, by receiving consumption-related data from the data concentrator of the adjacent cell and transmitting the received consumption-related data to the wide area network or to a data concentrator of another adjacent cell.

Unfortunately, both of the above-described proposed configurations of one-way endpoint devices suffer from certain difficulties. First, the performance of the first-level uni-directional communication links between one-way end-point devices and repeaters would depend on the type and quality of technology utilized in the repeaters. If a multitude of analog receivers working in parallel were used in a similar manner to that used in mobile applications, the size and weight of the analog receivers would be excessive for installation on poles (i.e., which is the most common location for repeaters). Alternatively, if smaller and lighter weight frequency scanning or hopping receivers were used, the performance of the automatic meter reading system may be unacceptable because such receivers are limited in scanning/hopping speed and in their ability to lock onto only one end-point device at a time.

A second difficulty of the proposed configurations relates to the requirement that the second-level bi-directional communication links between the repeaters and data concentrators would need dedicated communication links, thereby necessitating the use of specialized and expensive equipment. Because two-way radio links would, perhaps, be the most common form of link employed, special licensing of dedicated channels would also possibly be necessary. Additionally, two-way radio communication equipment is often delicate and very susceptible to adverse radio frequency environmental conditions.

Therefore, there is a need in the industry for a fixed-network system for automatic meter reading that enables the automatic reading of meter data from electric, natural gas and water meters which addresses these and other related, and unrelated, problems, difficulties, and/or shortcomings.

### SUMMARY OF THE INVENTION

Briefly described, the present invention comprises a fixed-network system, including apparatus and methods, for automatically collecting and processing commodity consumption-related data which includes a one-way local area network (i.e., a local area network in which data communications are in a single direction). More particularly, the present invention comprises a fixed-network system for automatically collecting and processing commodity consumption-related data from one-way endpoint devices which includes at least one local area network having only uni-directional communication of commodity consumption-related data therein. A local area network is associated with a geographical area from which the collection of commodity consumption-related data from at least one one-way endpoint device is desired by a user of the fixed-network system. Hence, a local area network is also referred to herein as a “cell”. Preferably, each local area network, or cell, includes a data concentrator, at least one repeater, and at least one, one-way endpoint device. The data concentrator and repeater connect for the uni-directional communication of commodity consumption-related data from the repeater to the data concentrator via a uni-directional communication link. Similarly, the repeater and one-way endpoint device connect, through a uni-directional communication link, for the uni-directional communication of commodity consumption-related data from the one-way endpoint device to the repeater.

The fixed-network system of the present invention enables a utility company, a meter reading and/or billing service provider, or other entity that reads meters to collect and process commodity consumption-related data which is measured and recorded by one-way endpoint devices during the consumption, by their consumers, of one or more commodities such as, for example and not limitation, electricity, natural gas, water, and steam. By virtue of the system's employment of local area networks which have only uni-directional communications of commodity consumption-related data therein, the fixed-network system utilizes a single communication structure (i.e., one-way communications), thereby reducing complexity as compared to prior art systems (i.e., which utilize two-way communications) and enabling the use of repeaters having transmitters that use existing, reliable, low-power, less-expensive technology (i.e., which are substantially the same as, if not identical to, the transmitters used by the one-way endpoint devices). The use of such uni-directional communications for commodity consumption-related data between a repeater and data concentrator also eliminates the need for time-keeping or time-control at the repeaters or endpoint devices. Instead, all time control functions are performed by the data concentrator.

Also, as noted, the fixed-network system of the present invention allows the use of less-expensive transmitters in the repeaters. By doing so, the cost of the repeaters becomes more dependent on the type of receiver employed therein. The cost of the repeaters (and, hence, the cost of the fixed-network), as a consequence, is more scaleable to coincide more closely with the requirements for the fixed-network. For example, if a particular application requires the collection of only monthly commodity consumption-related data from a one-way endpoint device, then the repeater associated and operative with that one-way endpoint device may be equipped with a less-expensive receiver. If, however, a particular application requires more frequent collection of commodity consumption-related data from a one-way endpoint device (i.e., including, for instance, the collection of interval data as is required for time-of-use, demand, or load survey applications), then the repeater associated and operative with that one-way endpoint device may be equipped with a more-expensive receiver capable of handling higher data rates.

Further, the fixed-network system of the present invention allows many utility companies, billing and/or meter reading service providers, and other similarly-positioned entities to, potentially, reduce costs associated with the collection and processing of commodity consumption-related data. Through the fixed-network system's ability to collect commodity consumption-related data from an already installed base of one-way endpoint devices, the fixed-network system enables the transition of such data collection away from mobile and handheld collection devices to a system which requires very few data collection-related personnel and which requires no special licensing of communication channels. As a consequence, a system user may become more profitable due, at least in part, to the decrease in labor and other costs associated with data collection.

Accordingly, it is an object of the present invention to improve the migrability of an automatic meter reading system from a system which employs mobile devices for data collection to a system which employs a fixed communication network for data collection.

Another object of the present invention is to minimize the cost associated with the conversion of an automatic meter reading system from a system which employs mobile devices for data collection to a system which employs a fixed communication network for data collection.

Still another object of the present invention is to enable the use of endpoint data collection devices which are communicable with mobile data collection devices in an automatic meter reading system that utilizes a fixed communication network for data collection and communication.

Still another object of the present invention is to maintain or improve the reliability of data communication in an automatic meter reading system being converted from a system which employs mobile devices for data collection to a system which employs a fixed communication network for data collection.

Still another object of the present invention is to enable the use of existing wide area communication network infrastructure as part of an automatic meter reading system.

Still another object of the present invention to simplify the communication interface between data repeaters and data concentrators of a fixed communication network of an automatic meter reading system.

Still another object of the present invention is to re-use existing and proven technology in the communication interface between data repeaters and data concentrators of a fixed communication network of an automatic meter reading system.

Still another object of the present invention is to reduce the maintenance requirements for data repeaters in a fixed communication network of an automatic meter reading system.

Still another object of the present invention is to decrease the energy consumption of data repeaters in a fixed communication network of an automatic meter reading system.

Still another object of the present invention is to enable the use of multiple one-way data communication protocols in the communication interface between data repeaters and data concentrators of a fixed communication network of an automatic meter reading system.

Still another object of the present invention is to reduce the cost of data repeaters employed in a fixed communication network of an automatic meter reading system.

Still another object of the present invention is to increase the number of endpoint data collection devices which may be served by each data concentrator of a fixed communication network of an automatic meter reading system.

Still another object of the present invention is to eliminate the performance of communication-related timing control by the data repeaters of a fixed communication network of an automatic meter reading system.

Still another object of the present invention is to eliminate the performance of communication-related timing control by endpoint data collection devices which communicate with a fixed communication network of an automatic meter reading system.

Other objects, features, and advantages of the present invention will become apparent upon reading and understanding the present specification when taken in conjunction with the appended drawings.

### BRIEF DESCRIPTION OF THE DRAWINGS

FIG. 1 is a block diagram representation of a local area network portion of a proposed, prior art fixed-network system for automatic meter reading.

FIG. 2 is a block diagram representation of a fixed-network system for automatic meter reading in accordance with the preferred embodiments of the present invention.

FIG. 3 is a block diagram representation of a local area network portion of a fixed-network system for automatic meter reading in accordance with a first preferred embodiment of the present invention.

FIG. 4 is a block diagram representation of a local area network portion of a fixed-network system for automatic meter reading in accordance with a second preferred embodiment of the present invention.

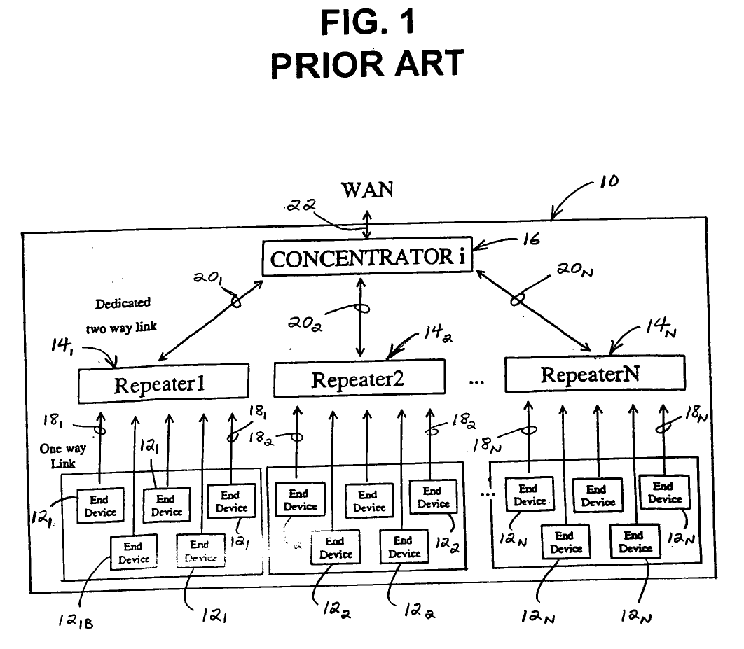

### DETAILED DESCRIPTION OF THE PREFERRED EMBODIMENTS

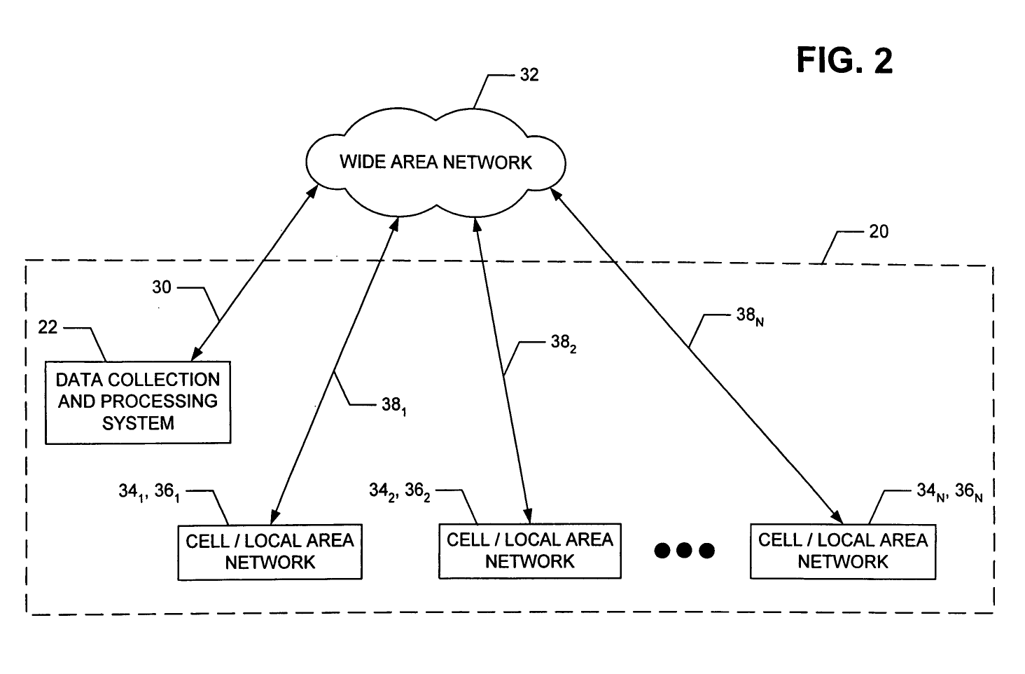

Referring now to the drawings, in which like numerals represent like components throughout the several views and an ellipsis indicates the presence of multiple similar components, FIG. 2 displays a fixed-network system for automatic meter reading 20 (also referred to herein as the “fixed-network system 20”) in accordance with the preferred embodiments of the present invention. The fixed-network system 20 comprises a data collection and processing system 22 (also referred to herein as the “system 22”), a plurality of data concentrators 24, a plurality of repeaters 26, and a plurality of one-way endpoint devices 28. The data collection and processing system 22, preferably, comprises a computer system (central or distributed) having appropriate hardware, software, and data communication interfaces to enable the system 22 to automatically read, collect, store, and process commodity consumption-related data from the plurality of one-way endpoint devices 28, thereby allowing a utility company, meter reading and/or billing service provider, or other user of the fixed-network system 20 to bill (including, for example and not limitation, under a time of use billing tariff) consumers or customers for their consumption of commodities such as electricity, natural gas, water, and steam. Also, the data collection and processing system 22, preferably, has the appropriate hardware, software, and data communication interfaces to allow a user of the system 22 to perform a load survey of a consumer's commodity consumption patterns, if any. The data collection and processing system 22 connects, via appropriate data communication interfaces and bi-directional communication links 30, to a wide area communication network 32 for bi-directional data communication with the plurality of data concentrators 24. According to the preferred embodiments of the present invention, the wide area communication network 32 (also referred to herein as the “wide area network 32”) includes, but is not limited to: the public switched telephone network (“PSTN”); analog or digital, wired and wireless communication networks; CPDP systems; cable television networks; satellite communication networks; and, other communication networks which enable data communication now or in the future.

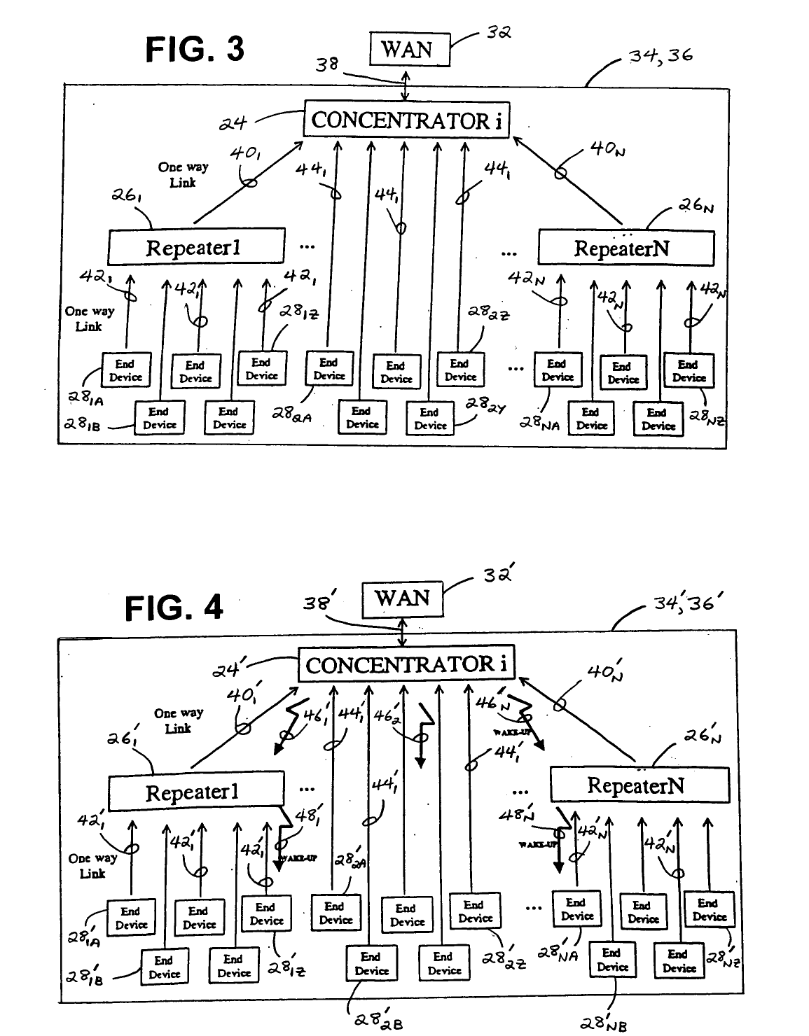

The plurality of data concentrators 24, the plurality of repeaters 26, and the plurality of one-way endpoint devices 28 of the fixed-network system 20 are arranged, as seen in FIG. 2, in a plurality of cells 34 which enable the collection of commodity consumption-related data for consumers in a desired geographical area. Each cell 34 of the plurality of cells 34 is associated with a portion of the desired geographical area, but may overlap with other cells 34. As illustrated in FIG. 3, each cell 34, preferably, comprises a local area network 36 (also referred to herein as “LAN 36”) including a data concentrator 24 of the plurality of data concentrators 24, a portion of the repeaters 26 of the plurality of repeaters 26 (i.e., respectively designated with subscripts 1-“N”), and a portion of the one-way endpoint devices 28 of the plurality of one-way endpoint devices 28. The data concentrator 24 has, preferably, a transmitter, a receiver, and a microprocessor with embedded software to control, through execution of the software, the operation of the transmitter and receiver, and to perform other necessary and appropriate functions. The transmitter of the data concentrator 24 connects, through an appropriate bi-directional communication link 38, to the wide area network 32 for the bi-directional communication of data therebetween. The receiver of the data concentrator 24 connects, as described below, to the transmitter of each repeater 26 of the cell 34.

Each repeater 26 of a cell 34 has, preferably, a transmitter, a receiver, and a microprocessor with embedded software to control, through execution of the software, the operation of the transmitter and receiver, and to perform other necessary and appropriate functions. The transmitter of each repeater 26 connects to the cell's data concentrator 24, through respective uni-directional wireless communication links 40 (i.e., respectively designated with subscripts 1-“N”), for the uni-directional communication of commodity consumption-related data from the repeater 26 to the data concentrator 24. The receiver of each repeater 26 connects to the transmitters of a respective group of the plurality of one-way endpoint devices 28 (i.e., respectively designated with numerical subscripts 1-“N” to identify the repeater 26 to which the one-way endpoint devices 28 connect, and with an alphabetic character A-Z to identify individual one-way endpoint devices 28), via respective uni-directional communication links 42, for the uni-directional communication of commodity consumption-related data from the one-way endpoint devices 28 to the respective repeaters 26. Notably, as depicted in FIG. 2, one or more groups of respective one-way endpoint devices 28 connect directly to data concentrator 24 for the uni-directional communication of commodity consumption-related data to the data concentrator 24 through respective uni-directional communication links 44 and without use of a repeater 26.

In accordance with the preferred embodiments of the present invention, the receivers of the data concentrators 24 and the plurality of repeaters 26 include many different types of receivers. Because the performance of the fixed-network system 20 is highly dependent upon the particular type of receivers selected for the data concentrators 24 and repeaters 26, great care must be taken in analyzing the performance requirements for the system 20 in order to select an appropriate receiver type. For example, if the primary use of a fixed-network system 20 is to collect and process commodity consumption-related data from one-way endpoint devices 28 once per month, then a relatively slow data transfer rate for the data concentrators 24 and repeaters 26 is acceptable. In such an implementation, slower and less expensive receivers such as scanning receivers may be employed in the data concentrators 24 and repeaters 26 as the data transfer rates required for the implementation do not warrant the use of a higher speed and more expensive receiver. However, if the primary use of a fixed-network system 20 is to collect and process interval commodity consumption-related data for time of use, demand, or load survey applications, then a relatively high data transfer rate for the data concentrators 24 and repeaters 26 is necessary in order to reduce data latency to a value of, perhaps, seconds. In such an implementation, faster and more expensive receivers such as digital multi-channel receivers (“DMRs”) may be used in the data concentrators 24 and repeaters 26 because the required data transfer rates warrant the additional speed and cost of the DMR. Typically, a DMR processes multiple frequency channels in parallel and is active again to receive data in the form of a message from a transmitting device within fractions of a message length after a previous message ends.

It should be noted that the performance of the fixed-network system 20 is less related to and dependent upon the data transfer rates of the transmitters employed in the plurality of repeaters 26, or on the data protocol produced by the transmitters and utilized for uni-directional communication links 40, 42, 44, than it is on the type of receivers selected for use. As a consequence, the fixed-network system 20 of the preferred embodiments employs the same type of transmitters in the plurality of repeaters 26 as are present in the system's one-way endpoint devices 28. By using the same type of transmitters and data protocol, the costs of implementing and maintaining the fixed-network system 20 are reduced since the transmitters are interchangeable and relatively inexpensive. Repeater transmitters and data protocols, acceptable in accordance with the preferred embodiments of the present invention, include for example and not limitation: very low-power transmitters (i.e., less than 0 dBm) which transmit commodity consumption-related data in short pulses according to the ENSCAN protocol; medium-power transmitters (i.e., less than 10 dBm) which transmit commodity consumption-related data in longer messages according to the SURF protocol; and, high-power transmitters (i.e., greater than 10 dBm) which, similar to the medium-power transmitters, transmit commodity consumption-related data using the SURF protocol.

The fixed-network system 20 of the first preferred embodiment employs one-way endpoint devices 28 which do not require the receipt of a wake-up signal in order to initiate the transmission of their commodity consumption-related data to respective repeaters 26. Instead, the one-way endpoint devices 28 transmit their commodity consumption-related data in a manner appropriate for their particular type, but which often includes transmission in a, generally, random manner at a rate of more than one transmission per second.

During operation of the fixed-network system 20, the one-way endpoint devices 28 collect and store therein appropriate commodity consumption-related data associated with the consumption of commodities such as electricity, natural gas, water, and steam by their respective consumers. At times appropriate for the respective type(s) of one-way endpoint devices 28 (described in more detail below), the one-way endpoint devices 28 retrieve and format (i.e., according to the protocol employed by the one-way endpoint devices 28) previously stored commodity consumption-related data for communication to the data collection and processing system 22. After formatting, the majority of the transmitters of the one-way endpoint devices 28 transmit, via uni-directional communication links 42, a signal (i.e., a message including the formatted commodity consumption-related data) to the receivers of their respectively associated repeaters 26. Note, however, that the transmitters of certain one-way endpoint devices 28 transmit, via uni-directional communication links 44, their signals directly to the receiver of data concentrator 24 of the cell 34 in which they reside. If so, the data concentrator 24, generally, operates with respect to the signals as if it were a repeater 26.

The repeaters 26, upon receiving the signals including commodity consumption-related data from the one-way endpoint devices 28, operate on the signals differently according to their respective receiver types. For instance, if a particular repeater 26 includes a scanning receiver that receives a signal from a particular one-way endpoint device 28, the repeater 26 utilizes its transmitter to transmit the received message to the data concentrator 24 of the cell 34 without reformatting the received message and before the repeater 26 can receive a signal from a different one-way endpoint device 28. If, alternatively, a particular repeater 26 includes a digital multi-channel receiver, the repeater 26 collects signals received from a multitude of one-way endpoint devices 28 during a period of time, reformats the messages together into a “hyper-message” containing commodity consumption-related data from the multitude of one-way endpoint devices 28, and uses its transmitter to transmit the hyper-message to the cell's data concentrator 24 via a respective uni-directional communication link 40. By reformatting the messages received from individual one-way endpoint devices 28 into a single hyper-message, the repeater 26 increases the data rate of the transmission to the cell's data concentrator 24. Typically, such reformatting results in up to 150 endpoint device messages per second being sent to the cell's data concentrator 24 with the same reliable, low-power, relatively low-cost transmitter as is used in the one-way endpoint devices 28. If higher repeater 26 to data concentrator 24 data rates are required for a particular installation or application, the simultaneous use of multiple frequencies may be employed to increase the data rate by, perhaps, as much as a factor of eight. However, the simultaneous use of multiple frequencies may add to the complexity of the repeater's transmitter and, hence, add to the cost of the repeater 26 while, possibly, decreasing the repeater's reliability.

Once the signals transmitted to the data concentrator 24 are received by its receiver (whatever type), the data concentrator 24 reformats the signals, as necessary and appropriate, and transmits signals representative of the received signals to the data collection and processing system 22 via bi-directional communication links 30, 38 and the wide area network 32. The data collection and processing system 22 then stores and processes the commodity consumption-related data from the one-way endpoint devices 28 to generate bills, time of use related data, load survey related data, and/or other desired forms of data or information based, at least in part, on the collected commodity consumption-related data.

FIG. 4 displays a fixed-network system 20′ according to a second preferred embodiment of the present invention which is substantially similar to that of the first preferred embodiment described above. However, in the second preferred embodiment, the data concentrator 24′ of each cell 34′ is equipped with an additional “wake-up” transmitter for transmitting a “wake-up” signal 46′ (i.e., a signal which instructs, as appropriate, repeaters 26′ and one-way endpoint devices 28′ to wake-up from a low-power consumption, hibernation mode) to the plurality of repeaters 26′ or directly to one or more groups of one-way endpoint devices 28′. Also, the repeaters 26′ of each cell 34′ are equipped with an additional “wake-up” receiver and “wake-up” transmitter for, respectively, receiving a “wake-up” signal 46′ from the cell's data concentrator 24′ and transmitting a “wake-up” signal 48′ to their respective groups of associated one-way endpoint devices 28′. Similarly, the one-way endpoint devices 28′ include a “wake-up” receiver for receiving a “wake-up” signal 46′, 48′ from a data concentrator 24′ or repeater 26′.

In operation according to the second preferred embodiment, a data concentrator 24′ of a cell 34′ generates a “wake-up” signal 46′ and uses its “wake-up” transmitter to transmit the “wake-up” signal 46′, in a time-controlled or not time-controlled manner, to the plurality of repeaters 26′ of its cell 34′ and, perhaps, to one or more groups of one-way endpoint devices 28′ which communicate directly with the data concentrator 24′. Upon receipt of the data concentrator's “wake-up” signal 46′ by the “wake-up” receivers of the repeaters 26′, the repeaters 26′ awaken from their low-power consumption, hibernation mode, generate a “wake-up” signal 48′, and transmit the generated “wake-up” signal 48′, using their “wake-up” transmitters, to their respectively associated groups of one-way endpoint devices 28′. After the “wake-up” receiver of a one-way endpoint device 28′ receives a “wake-up” signal 46′, 48′ from its associated data concentrator 24′ or repeater 26′, the one-way endpoint device 28′ retrieves commodity consumption-related data from its memory, formats the data appropriately for transmission according to the particular protocol used by the one-way endpoint device 28′, and transmits the formatted commodity consumption-related to its associated repeater 26′ via uni-directional communication link 42′, or if the one-way endpoint device 28′ communicates directly with the cell's data concentrator 24′, to the cell's data concentrator 24′ via uni-directional communication link 44′. Once the one-way endpoint device 28′ transmits its commodity consumption-related data, the operation of the second embodiment of the present invention is substantially the same as that of the first preferred embodiment and, hence, no further description is required here.

The practical implementations of the fixed-network system 20 of the present invention take on a variety of different forms. Therefore, the following descriptions of practical exemplary implementations have been included herein to provide further clarification of the preferred embodiments.

Exemplary Electric Meter Implementation

The first preferred embodiment of the present invention is implementable to collect electricity consumption-related data from a plurality of electric meters positioned within a plurality of cells 34. Each meter, or one-way endpoint device 28, is fitted with an R300 one-way, radio frequency, low-power module which transmits electricity consumption-related data randomly at a rate of twice per second using the ENSCAN protocol to a respectively associated repeater 26 through uni-directional communication link 42. The R300 module is available from Schlumberger Resource Management Services, Inc. of West Union, S.C. Each repeater 26 of the plurality of repeaters 26 is positioned at a fixed location, preferably, within 800 feet of the locations of the one-way endpoint devices 28 of the group of one-way endpoint devices 28 with which the repeater 26 is respectively associated. Each repeater 26 is also, preferably, positioned at least six feet above ground level. If the repeaters 26 have highly-sensitive receivers, each repeater 26 may interact with, possibly, as many as 100 to 150 one-way endpoint devices 28. Each repeater 26 is further equipped with an R300 one-way, radio frequency, low-power transmitter to randomly transmit electricity consumption-related data to the data concentrator 24 via uni-directional communication link 40.

The data concentrator 24 of each cell 34 is positioned at least six feet above ground level. As a result of the relationship between the data concentrator 24 and repeaters 26 of each cell 34, the repeater-to-concentrator available range is much larger than the endpoint device-to-repeater available range for the same amount of power radiated from the respective and identical transmitters. Generally, such an arrangement results in an available range increase on the order of a factor of two, thereby enabling each cell 34 to include approximately six to ten repeaters 26 which transmit one-way messages to the cell's data concentrator 24. It should be understood, however, that the exact number of repeaters 26 employable within a particular cell 34 depends on other factors as well, including terrain and other deployment parameters.

Exemplary Water Meter Implementation

The first preferred embodiment of the present invention is also implementable to collect water consumption-related data from a plurality of water meters positioned within a plurality of cells 34. In this exemplary implementation substantially similar to the above-described exemplary electric meter implementation, each meter, or one-way endpoint device 28, is fitted with an R900 one-way, radio frequency, low-power unit which transmits water consumption-related data randomly using the SURF protocol to a respectively associated repeater 26 through uni-directional communication link 42. The R900 unit is available from Schlumberger Resource Management Services, Inc. of Tallassee, Ala. The data concentrators 24 and repeaters 26 are positioned in substantially the same relative positions as their counterparts in the above-described exemplary implementation. Also, the transmitters of the repeaters 26 are, preferably, the same transmitters as are used in the R900 modules. However, the receivers of the data concentrators 24 and repeaters 26 must be capable of receiving data using the SURF protocol.

Exemplary Gas Meter Implementation

The second preferred embodiment of the present invention is implementable to collect natural gas consumption-related data from a plurality of gas meters positioned within a plurality of cells 34′. In this exemplary implementation, each one-way endpoint device 28′ of the fixed-network system 20′ comprises a one-way ERT device which is available from Itron, Inc. of Spokane, Wash. Each data concentrator 24′ and repeater 26′ is, notably, equipped with receivers and transmitters capable of communications using the ERT protocol. Each data concentrator 24′ of the system 20′ is also equipped with a “wake-up” transmitter, and each repeater 26′ of the system 20′ also has a “wake-up” receiver and transmitter. In operation, the data concentrator 24′ of each cell 34′ transmits a “wake-up” signal 46′ to the one-way endpoint devices 28′ with which it directly communicates and to the “wake-up” receiver of each repeater 26′ of the data concentrator's cell 34′. In response to receiving a “wake-up” signal 46′ directly from the data concentrator 24′, the one-way endpoint devices 28′ transmit their natural gas consumption-related data to the data concentrator 24′. In response to receiving a “wake-up” signal 46′ from the data concentrator 24′, the repeaters 26 transmit a “wake-up” signal 48′ to their associated one-way endpoint devices 28′. Upon receipt of a “wake-up” signal 48′ from their associated repeater 26′, the one-way endpoint devices 28′ transmit their natural gas consumption-related data to the repeaters 26′ which, subsequently, transmit the natural gas consumption-related data to their cell's data concentrator 24′.

It should be understood that the scope of the present invention comprises fixed-network systems which include other one-way endpoint devices, receivers, transmitters, repeaters, and data concentrators capable of wireless data communication therebetween which are available now or in the future. It should also be understood that the scope of the present invention includes fixed-network systems which employ a combination of different meter, or one-way endpoint device, types and the use of different protocols within the same or different cells.

Whereas this invention has been described in detail with particular reference to its most preferred embodiments, it is understood that variations and modifications can be effected within the spirit and scope of the invention, as described herein before and as defined in the appended claims. The corresponding structures, materials, acts, and equivalents of all means or step plus function elements, if any, in the claims below are intended to include any structure, material, or acts for performing the functions in combination with other claimed elements as specifically claimed.

1. A system for collecting commodity consumption-related data from an endpoint device, said system comprising:
a data collection and processing device for receiving commodity consumption-related data;
a wide area network operable to receive commodity consumption-related data and to communicate received commodity consumption-related data to said data collection and processing device; and,
a local area network operable to communicate commodity consumption-related data to said wide area network, said local area network including a plurality of components and being adapted to utilize only uni-directional data communications between said components.

2. The system of claim 1, wherein said plurality of components includes
a data concentrator for receiving commodity consumption-related data and for communicating received commodity consumption-related data to said wide area network, and
a repeater operable to communicate with said data concentrator using only uni-directional communications therebetween.

3. The system of claim 2, wherein said plurality of components further includes an endpoint device for communicating commodity consumption-related data to said repeater, said endpoint device being operable to communicate with said repeater using only uni-directional communications therebetween.

4. The system of claim 1, wherein said plurality of components includes
a data concentrator for receiving commodity consumption-related data and for communicating received commodity consumption-related data to said wide area network, and
an endpoint device for communicating commodity consumption-related data to said data concentrator, said endpoint device being operable to communicate with said data concentrator using only uni-directional communications therebetween.

5. The system of claim 1, wherein said plurality of components includes
a repeater having a transmitter operable to transmit commodity consumption-related data, and
an endpoint device having a transmitter operable to transmit commodity consumption-related data,
wherein said transmitter of said repeater and said transmitter of said endpoint device are substantially similar.

6. The system of claim 1, wherein said plurality of components includes
a data concentrator having a receiver operable to receive commodity consumption-related data,
a repeater having a receiver operable to receive commodity consumption-related data, and
wherein said receiver of said data concentrator and said receiver of said repeater are substantially similar.

7. The system of claim 1, wherein said plurality of components includes a repeater having a receiver operable to receive commodity consumption-related data, and wherein said receiver of said repeater includes a scanning receiver.

8. The system of claim 1, wherein said plurality of components includes a plurality of endpoint devices operable to transmit commodity consumption-related data, and a repeater operable to receive commodity consumption-related data from said plurality of endpoint devices and to process received commodity consumption-related data in parallel.

9. The system of claim 1, wherein said plurality of components includes a repeater having a receiver operable to receive commodity consumption-related data, and wherein said receiver of said repeater includes a digital multi-channel receiver.

10. The system of claim 1, wherein said plurality of components includes
an endpoint device for transmitting a message including commodity consumption-related data in a particular format, and
a repeater operable to receive the message from said endpoint device and for transmitting the message in the same format.

11. The system of claim 1, wherein said plurality of components includes
a plurality of endpoint devices for transmitting commodity consumption-related data, and
a repeater operable to receive commodity consumption-related data from said plurality of endpoint devices, for formulating a message including commodity consumption-related data received from at least two endpoint devices of said plurality of endpoint devices, and for transmitting said message.

12. A local area network of a network system for collecting commodity consumption-related data, said local area network comprising:
a data concentrator for receiving commodity consumption-related data;
an endpoint device for communicating commodity consumption-related data; and,
a repeater communicatively interposed between said data concentrator and said endpoint device, said repeater being operable to communicate with said data concentrator using only uni-directional communications therebetween, said repeater being operable to communicate with said repeater using only unidirectional communications therebetween.

13. The local area network of claim 12, wherein said endpoint device includes a transmitter for transmitting commodity consumption-related data, wherein said repeater includes a transmitter for transmitting commodity consumption-related data, and wherein said transmitter of said endpoint device and said transmitter of said repeater are substantially similar.

14. The local area network of claim 12, wherein said data concentrator includes a receiver for receiving commodity consumption-related data, wherein said repeater includes a receiver for receiving commodity consumption-related data, and wherein said receiver of said data concentrator and said receiver of said repeater are substantially similar.

15. The local area network of claim 12, wherein said endpoint device is operable to transmit commodity consumption-related data in a message having a particular format, and wherein said repeater is operable to receive the message from said endpoint device and to transmit the message in the same format.

16. The local area network of claim 12, wherein said endpoint device is a first endpoint device and said local area network further comprises a second endpoint device, wherein said first endpoint device is operable to transmit commodity consumption-related data in a first message, wherein said second endpoint device is operable to transmit commodity consumption-related data in a second message, and wherein said repeater is operable to receive the first message and the second message, to formulate a third message including the commodity consumption-related data of the first message and the commodity consumption-related data of the second message, and to transmit the third message to said data concentrator.

17. The local area network of claim 12, wherein said repeater includes a scanning receiver for receiving commodity consumption-related data.

18. The local area network of claim 12, wherein said repeater includes a digital multi-channel receiver for receiving commodity consumption-related data.

19. The local area network of claim 12, wherein said endpoint device is a first endpoint device and said local area network further comprises a second endpoint device for communicating commodity consumption-related data, and wherein said repeater is operable to receive commodity consumption-related data from said first and second endpoint devices and to process received commodity consumption-related data in parallel.

20. A method of collecting commodity consumption-related data through a communications network adapted for meter-reading, the method comprising the steps of:
receiving commodity consumption-related data at a repeater of a communications network adapted for meter-reading; and,
transmitting the received commodity consumption-related from the repeater to a data concentrator of the communications network through a uni-directional communication link between the repeater and the data concentrator.

21. The method of claim 20, wherein the step of receiving includes receiving at the repeater commodity consumption-related data from an endpoint device through a uni-directional communication link between the repeater and the endpoint device.

22. The method of claim 20, wherein the method further includes a step of transmitting the commodity consumption-related data from an endpoint device to the repeater with a transmitter associated with the endpoint device, wherein the step of transmitting the received commodity consumption-related data includes transmitting the received commodity consumption-related data with a transmitter of the data repeater, and wherein the transmitter associated with the endpoint device and the transmitter of the data repeater are substantially similar.

23. The method of claim 20, wherein the step of receiving at the repeater includes receiving commodity consumption-related data with a receiver of the data repeater, wherein the method further comprises a step of receiving at a receiver of the data concentrator transmitted commodity consumption-related data from the data repeater, and wherein the receiver of the data repeater and the receiver of the data concentrator are substantially similar.

24. The method of claim 20, wherein the step of receiving includes receiving commodity consumption-related data in a first format, and wherein the step of transmitting includes transmitting the received commodity consumption-related data in a second format.

25. The method of claim 24, wherein the first format and the second format are the same.

26. The method of claim 24, wherein the second format enables the transmitting in a single message of received commodity consumption-related data from a plurality of endpoint devices.
